(19) United States
(12) Patent Application Publication
(10) Pub. No.: US 2003/0034727 A1
(43) Pub. Date: Feb. 20, 2003

(54) Projection type cathode ray tube

(76) Inventors: Hideki Okada, Tokyo (JP); Yuuichi Ushizala, Saitama (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/765,578

(22) Filed: Jan. 22, 2001

(30) Foreign Application Priority Data
Jan. 24, 2000 (JP) P2000-017926

(51) Int. Cl. H01J 29/88

(52) U.S. Cl. 313/478

(57) ABSTRACT

A projection type cathode ray tube which has excellent optical characteristics and endurance thanks to the enhanced cooling effect and is manufactured efficiently at low cost. The thickness of a panel is uniform throughout the panel except its peripheral portion contacting a coupler (a cooling liquid holder). The cooling effect on the panel by a cooling system is uniform throughout the entire panel, enhancing the optical characteristics and endurance of the panel. In the manufacturing process applying heat to the panel, a reduction in the cooling temperature and the cooling time causes no difference in temperature, achieving uniform cooling. The panel except its peripheral portion is a curved portion in the concave form. For the interest of higher adhesion, it is sufficient to polish only the peripheral portion adhering to the edge of the opening on the rear side of the coupler, which reduces the polishing time.

### BACKGROUND OF THE INVENTION

1. Field of the Invention

The invention relates to a projection type cathode ray tube used in, for example, a projector for projecting a picture on a screen.

2. Description of the Related Art

A projector in accordance with the related art comprises, as shown in FIG. 1A and FIG. 1B, single-color projection type cathode ray tubes 101 arranged side by side for producing red (R), green (G) and blue (B) images. In the front face of each of the cathode ray tubes 101, provided is a projection lens 102. In the projector, each of the cathode ray tubes 101 produces a picture, which is enlarged by the projection lens 102 for image formation on a large-size screen 103 forward of the projector. The projector thus achieves color display on a large-size screen. FIG. 1A and FIG. 1B illustrate a projector of the front projection type in which a picture is projected on the front face of the screen 103; some projectors, however, are of the rear projection type in which a picture is projected on the rear face of a screen via mirrors.

FIG. 2 illustrates the structure of a common projection type cathode ray tube used in the projector in accordance with the related art. The projection type cathode ray tube requires high intensity for the purpose of projecting a picture with sufficient intensity on the large-size screen 103 (see FIG. 1A and FIG. 1B). It is therefore necessary to operate the main body 110 of the cathode ray tube at a high voltage to emit an electron beam having high energy from a high intensity electron gun (riot shown) toward a panel 111, on which a fluorescent screen 112 is formed. However, this makes the panel 111 in the form of a glass plate hot and causes thermal displacement, resulting in a deterioration in optical characteristics and the degradation of endurance of a device. Moreover, the possibility arises that the panel 111 will be broken.

To avoid this problem, the cathode ray tube comprises a cooling system 120 on a front surface 111a of the panel 111. The purpose of the cooling system 120 is to cool the panel 111, which has become hot. The cooling system 120 comprises a cooling liquid holder 121, which is referred to as a coupler, mounted on the front surface 111a of the panel 111. The hermetic seal between the cooling liquid holder 121 and the panel 111 is formed by an adhesive 130 such as silicone rubber. A cooling liquid 122 having a refractive index equal to the refractive index of glass is sealed in the cooling liquid holder 121. Thus, an opening 121a on the rear side of the cooling liquid holder 121 is blocked by the front surface 111a of the panel 111 of the main body 110 of the cathode ray tube. On the front side of the cooling liquid holder 121, a concave incidence lens 140 is mounted with a hermetic seal formed by an O ring 150, and thereby, another opening on the front side of the cooling liquid holder 121 is blocked.

On the other hand, in an attempt at minimizing the projection distance to meet the demands for a reduction in the size and depth dimension of a projector, the inner surface 111b of the panel 111 of the main body 110 of the cathode ray tube is a curved surface (or spherical surface) radiused inwardly. The curved surface of the inner surface 111b offers orientation with respect to the light, thereby serving as a lens. This results in a reduction in the focal length of the entire lens system including the projection lens 102 (see FIG. 1A and FIG. 1B).

FIG. 3 illustrates in section the panel 111 processed in accordance with the related art. During the process of formation of the panel 111, in the step of exhausting the inside of the panel 111 to a vacuum, the center portion of the front surface 111a is pressure-formed into the recessed portion 111c curved inwardly. Then, in the step of sealing the front surface (outer surface) 111a of the panel 111 with the rear side of the cooling liquid holder 121 using the adhesive 130 (see FIG. 2), the entire front surface 111a is polished and planarized for enhancing its adhesion.

The processing of the panel 111 as described above causes some problems as follows. Firstly, the inner surface 111b of the panel 111 of the main body 110 of the cathode ray tube is a curved surface, but the front surface 111a is a planar surface. The thickness of the panel 111 is large in the center portion and small in the peripheral portion. The difference between the thickness of the panel 111 in the center portion and in the peripheral portion is considerably large. Therefore, in the center portion of the panel 111 with a large thickness, sufficient cooling effect of the cooling system 120 is not achieved. This causes insufficient intensity and the degradation of the fluorescent screen 112, resulting in problems such as a deterioration in optical characteristics and the degradation in endurance of a device.

Secondly, in the step of attaching the rear side of the cooling liquid holder 121 to the front surface 111a of the panel 111 of the main body 110 of the cathode ray tube using the adhesive 130 such as silicone rubber, it is necessary to heat silicone rubber or the like to high temperatures for setting with ultraviolet radiation. Since the panel 111 is also heated in this step, it is necessary to cool the panel 111. However, because of the considerably large difference between the thickness of the panel 111 in the center portion and in the peripheral portion, the rapid cooling of the panel 111 causes a difference in temperature, resulting in the possibility that strain will occur inside the glass-made panel 111 and the panel 111 will be broken. It is possible to avoid this problem by cooling the panel 111 slowly instead of rapid cooling. However, slow cooling requires long cooling time, and therefore decreases the manufacturing efficiency.

Thirdly, the panel 111 is also heated in the step of exhausting the inside of the main body 110 of the cathode ray tube to a vacuum and in the step of glass fusing the panel 111 of the main body 110 of the cathode ray tube to a funnel 113. Thus, long cooling time is further required, causing a similar problem of poor manufacturing efficiency.

Moreover, in the projector in accordance with the related art, in the step of sealing the front surface (outer surface) 111a of the panel 111 with the rear side of the cooling liquid holder 121 by adhesion, it is necessary to polish the front surface 111a of the panel 111 for enhancing its adhesion. Since the front surface 111a after pressure-forming is a substantially plane surface except for the recessed portion 111c in the center portion, it is necessary to polish the entire front surface 111a. This requires a number of man-hours for processing, causing a problem of poor manufacturing efficiency and high manufacturing cost.

An example of attempts to solve such a problem is Publication of Japanese Unexamined Patent Application No. Hei 5-13023 proposing a cathode ray tube having a panel with a uniform thickness. However, the proposal does not involve sufficient consideration in applying the proposal to an actual projection type cathode ray tube; for example, little thought is given to cooling by the cooling system. Moreover, according to the proposal, the thickness of the panel is uniform across the panel, without special consideration in polishing the front surface (outer surface) of the panel. Therefore, the proposal fails to provide satisfactory solution to the problem such as poor manufacturing efficiency and high manufacturing cost.

### SUMMARY OF THE INVENTION

The invention has been made to overcome the foregoing problems. An object of the invention is to provide a projection type cathode ray tube which exhibits excellent optical characteristics and endurance by enhancing the cooling effect and is manufactured with high manufacturing efficiency at low manufacturing cost.

A projection type cathode ray tube in accordance with the invention comprises: a main body comprising a panel on which at least phosphor is provided, the panel being formed in the inwardly curved form with a uniform thickness; and a cooling system which has an opening facing the panel, and is filled with a cooling liquid for cooling the panel so that the cooling system makes contact with the panel through the opening.

In a projection type cathode ray tube in accordance with the invention, the thickness of the panel of the main body of the cathode ray tube is almost uniform across the panel except for the portion which is in contact with the sealing member. Therefore, the uniform cooling effect on the panel by the cooling liquid holder is obtained. Furthermore, in cooling the panel heated in the manufacturing process, lowering the cooling temperature to reduce the cooling time causes no difference in temperature, which enables uniform cooling. In addition, only the portion of the front surface of the panel which is in contact with the sealing member is polished, which contributes a reduction in the polishing time and the number of man-hours for processing.

Other and further objects, features and advantages of the invention will appear more fully from the following description.

### BRIEF DESCRIPTION OF THE DRAWINGS

FIG. 1A is a plan view of a projector in accordance with the related art.

FIG. 1B is a side elevational view of the projector in accordance with the related art.

FIG. 2 is a sectional view of part of a projection type cathode ray tube in accordance with the related art.

FIG. 3 is a sectional view for illustrating processing of a panel of the projection type cathode ray tube shown in FIG. 2 in accordance with the related art.

FIG. 4 is a sectional view of part of a projection type cathode ray tube in accordance with the invention.

FIG. 5 is a sectional view for illustrating processing of a panel of the projection type cathode ray tube shown in FIG. 4.

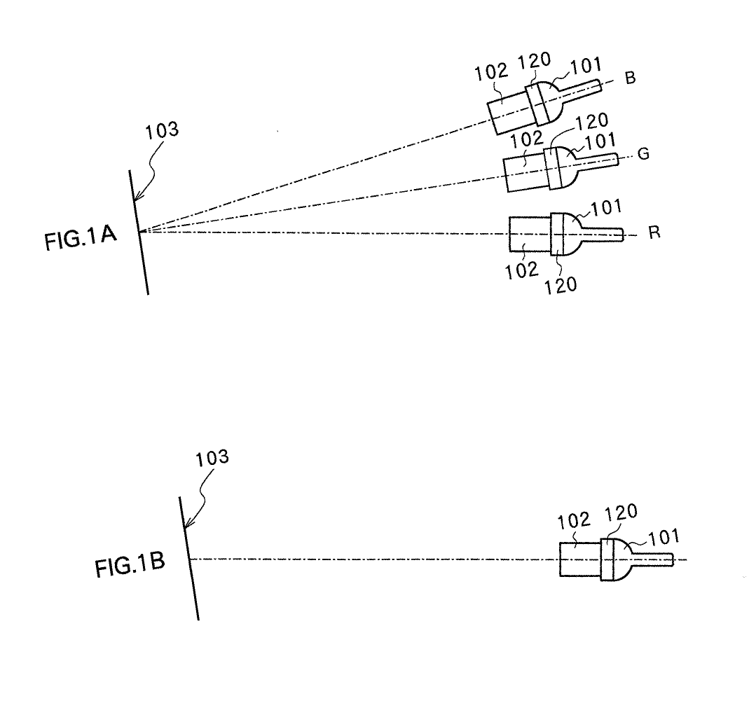

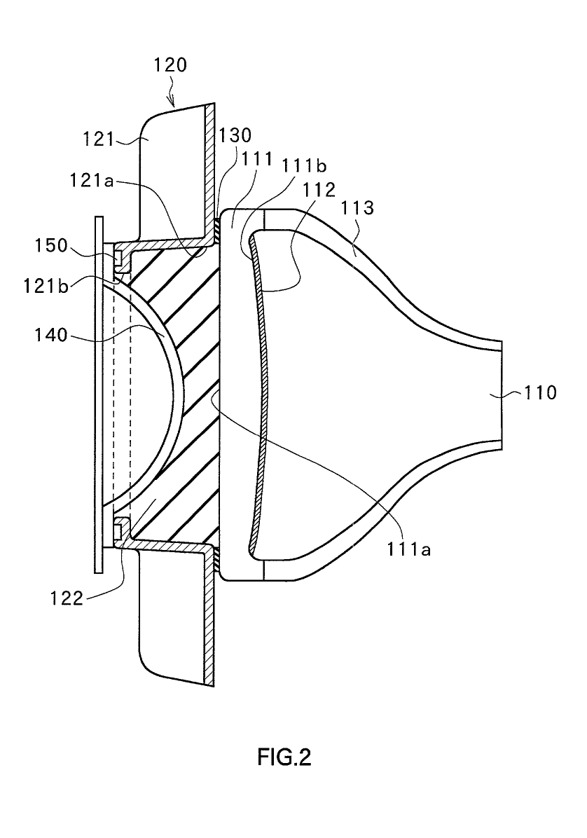

### DETAILED DESCRIPTION OF THE PREFERRED EMBODIMENTS

Preferred embodiments of the invention will now be described in detail below with reference to the drawings.

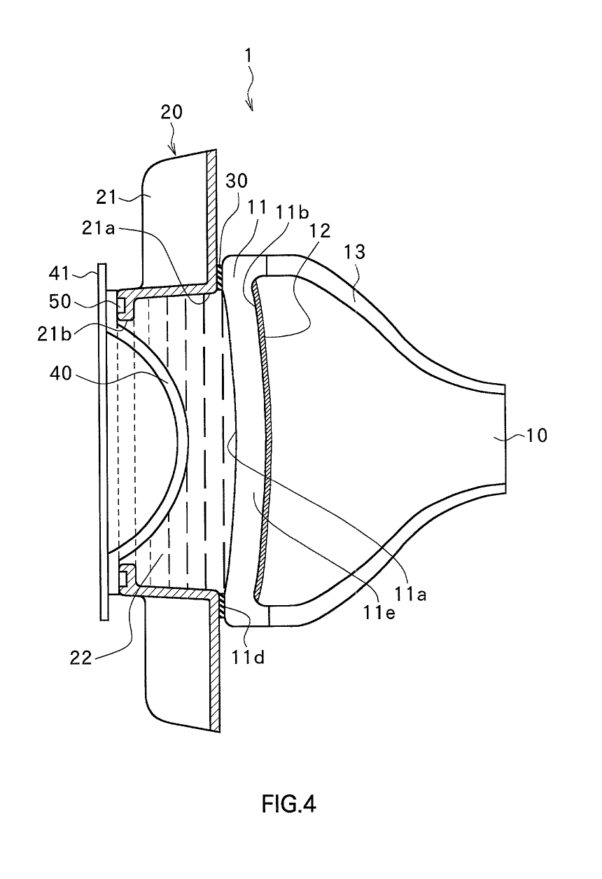

As shown in FIG. 4, a projection type cathode ray tube 1 in accordance with the embodiment comprises a main body 10 of the cathode ray tube, a cooling system 20 and an incidence lens 40. The cooling system 20 is mounted on the side of the front surface (outer surface) 11a of the main body 10 of the cathode ray tube. The incidence lens 40 is provided on the front side of the cooling system 20.

The main body 10 of the cathode ray tube is assembled by fusing a panel 11, a funnel 13 and a neck (not shown). The panel 11 is made of glass. The funnel 13 is in the form of a funnel and is made of a glass tube. The neck is in the cylindrical form and is made of a glass tube. The neck incorporates electron guns (not shown) for emitting electron beams for producing red, green and blue images based on color signals outputted from a color signal output circuit. The inside of the main body 10 of the cathode ray tube is in a high vacuum.

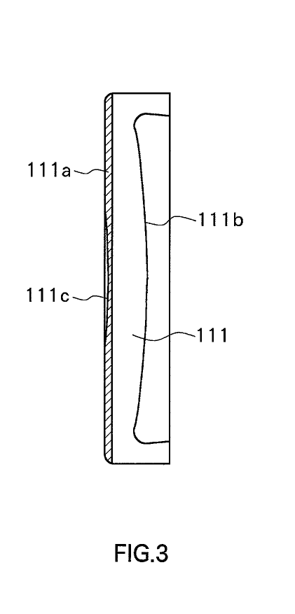

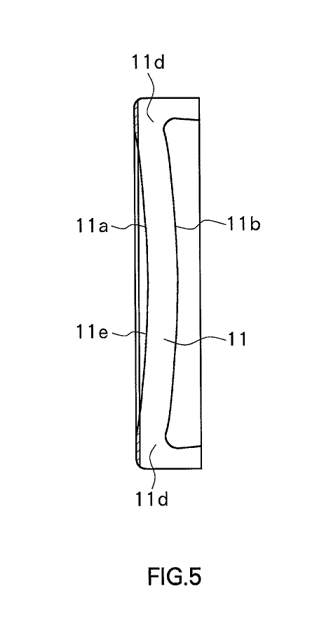

The panel 11 is pressure-formed as shown in FIG. 5. A front surface (outer surface) 11a except for a peripheral portion 11d is a curved surface (or spherical surface) having a curvature equal to the curvature of an inwardly-radiused curved surface (or spherical surface) of an inner surface 11b. The front surface (outer surface) 11a except for the peripheral portion 11d forms a curved portion 11e in the concave form. However, the outer surface 11a and the inner surface 11b may have different curvatures. In the curved potion 11e, the outer surface 11a of the panel 11 has a uniform glass thickness. The thickness of the panel 11 is in the order of, for example, 4 to 11 mm in consideration of prevention against explosion. It is to be noted that the outer surface 11a is easily pressure-formed into the curved portion 11e in the concave form as in the embodiment, since the center portion of the outer surface 111a (see FIG. 3) is also in the concave form in the related art. The form of the panel 11 is not adversely influenced when the panel 11 is taken off from a mold.

On the inner surface 11b of the panel 11, formed is a single-color fluorescent screen 12 for producing a red, green or blue image. The fluorescent screen 12 is formed by, for example, precipitation method. The fluorescent screen 12 emits light when struck by an electron beam emitted from an electron gun (not shown). The purpose of forming the inner surface 11b as a curved surface is, as in the related art, to reduce the focal length.

The peripheral portion lid of the front surface 11a of the panel 11 is a substantially planar surface. The width of the peripheral portion 11d is in the order of, for example, 6 to 10 mm. Since the peripheral portion 11d of the panel 11 adheres to and is sealed with a cooling liquid holder 21 in the cooling system 20, the peripheral portion 11d is polished using, for example, cerium oxide for enhancing its adhesion. The detailed description of the cooling liquid holder 21 and the cooling system 20 will be given below.

The cooling system 20 comprises the cooling liquid holder 21 and a cooling liquid 22. The cooling liquid holder 21 is a holder for a cooling liquid. The cooling liquid 22 fills and is sealed in the cooling liquid holder 21. The cooling liquid holder 21 is made by, for example, die casting of alloys of, for example, aluminum and zinc. The cooling liquid holder 21 is hollow. The cooling liquid holder 21 is in the form of a frame body. On the rear side of the cooling liquid holder 21, formed is an opening 21a. The opening 21a has a diameter a little smaller than the outside dimensions of the panel 11. On the front side of the cooling liquid holder 21, another opening 21b is formed. The opening 21b has a diameter almost equal to the lens diameter of the incidence lens 40. The cooling liquid 22 is a clear liquid having a refractive index almost equal to the refractive index of glass; for example, a mixed solution of ethylene glycol and glycerin.

The incidence lens 40 is a concave lens comprised of a spherical plate curved inwardly in the form of a hemisphere. The incidence lens 40 is positioned at the latest stage of the projection lens system comprising a plurality of lenses (not shown).

To the front surface (outer surface) 11a of the panel 11 of the main body 10 of the cathode ray tube, attached is the rear side of the cooling liquid holder 21. The polished peripheral portion 11d of the front surface 11a of the panel 11 adheres to the edge of the opening 21a on the rear side of the cooling liquid holder 21 using the adhesive 30 as a sealing member. The adhesive 30 is made of silicone resin such as silicone rubber. The adhesive 30 sets by, for example, ultraviolet radiation to make completely absolute contact between the peripheral portion lid of the outer surface 11a of the panel 11 and the edge of the opening 21a on the rear side of the cooling liquid holder 21, thereby forming a hermetic seal therebetween. Thus, the opening 21a on the rear side of the cooling liquid holder 21 is blocked by the front surface 11a of the panel 11.

To the front side of the cooling liquid holder 21, attached is the incidence lens 40. A lens securing plate 41 in the ring form is fixed with screws to the mounted position (not shown) formed on the front side of the cooling liquid holder 21. Thereby, the incidence lens 40 is sealed with and mounted on the front side of the cooling liquid holder 21 with an O ring 50 in between. Thus, the opening 21b on the front side of the cooling liquid holder 21 is blocked by the incidence lens 40.

As noted above, both the front side and the rear side of the cooling liquid holder 21 is hermetically sealed, and the inside space thus sealed is filled with the cooling liquid 22. The cooling liquid 22 changes in viscosity when the panel 11 becomes hot due to an electron beam having high energy emitted from a high intensity electron gun (not shown), causing a change in temperature. The changes in viscosity and temperature cause natural convection of the cooling liquid 22 in the cooling liquid holder 21. Thus, the cooling liquid 22 cools the panel 11 and makes the temperature uniform. In the meanwhile, the cooling liquid 22 serves as a medium for applying heat to the entire cooling liquid holder 21. The cooling liquid holder 21 thus heated dissipates heat as a heat sink. Moreover, the cooling liquid 22 is a clear liquid having a refractive index substantially equal to the refractive index of glass. The cooling liquid is, therefore, capable of suppressing reflection at the interface between the panel 11 and the incidence lens 40, and thereby enhancing the contrast of the picture.

As described above, in accordance with the projection type cathode ray tube of the embodiment, the thickness of the panel 11 of the main body 10 of the cathode ray tube is uniform except for the peripheral portion 11d where the panel 11 adheres to the cooling liquid holder 21. This enables the cooling system 20 to cool the panel 11 uniformly, enhancing the cooling effect. Even if the panel 11 is irradiated with electron beams having high energy, the uniform and sufficient cooling effect is obtained, and therefore, the degradation of the fluorescent screen 12 is minimized. This makes it possible, for example, to project a picture of higher intensity, enabling the enhancement of the optical characteristics and endurance of the panel 11.

The thickness of the panel 11 of the main body 10 of the cathode ray tube is uniform except for the peripheral portion lid. This produces another beneficial effect as follows. The manufacturing process involves, for example, a step of attaching the rear side of the cooling liquid holder 21 to the front side 11a of the panel 11 with the adhesive 30 such as silicone rubber, or a step of exhausting the inside of the main body 10 of the cathode ray tube to a vacuum, or a step of fusing the panel 11, the funnel 13 and the neck (not shown) of the main body 10 of the cathode ray tube. The panel 11 is heated in these steps in the manufacturing process. In cooling the panel 11 heated in these steps, lowering the cooling temperature to reduce the cooling time causes no difference in temperature, achieving uniform cooling. This enables an enhancement in the manufacturing efficiency.

Furthermore, the front surface 11a of the panel 11 except for the peripheral portion 11d, that is, the curved portion 11e, is in the concave form. Therefore, higher adhesion is obtained by polishing only the peripheral portion 11d, where the panel 11 adheres to the edge of the opening 21a on the rear side of the cooling liquid holder 21. This enables a reduction in the polishing time, a reduction in the number of man-hours for processing, an enhancement of the manufacturing efficiency, and a cost reduction. The curved portion 11e remains unpolished and constitutes part of the optical system. However, this causes no problems or influences because slight projections or recesses in the front surface 11a of the panel 11 is filled in with the cooling liquid 22 having a refractive index substantially equal to the refractive index of glass, and because a picture is formed on a screen forward of the front surface 11a.

The invention has been described by referring to the embodiment above. However, the invention is not limited to the above-described embodiment but various changes and modifications are possible. For example, the above-described embodiment adopts the silicone sealing technique in which the cooling system 20 is mounted on the main body 10 of the cathode ray tube with the adhesive 30 as a sealing member made of silicone resin such as silicone rubber. However, it may be also possible to adopt the mechanically sealing technique in which the cooling system 20 and the main body 10 of the cathode ray tube are arranged face to face with a sealing member such as an O ring in between and then closely attached to each other by pressing them with a flat spring in the case of adopting the mechanically sealing technique, the portion of the front surface 11a which contacts a sealing member such as an O ring constitutes the peripheral portion 11d to be polished.

Moreover, the above-described embodiment utilizes optical coupling in which the opening 21b on the front side of the cooling liquid holder 21 is blocked by the incidence lens 40. However, it may be possible to utilize air coupling in which the opening 21b on the front side of the cooling liquid holder 21 is blocked by a glass plate.

Furthermore, in the above-described embodiment, the curvature of the curved portion 11e of the front surface 11a of the panel 11 is equal to the curvature of the curve of the inner surface 11b so that the thickness of the panel 11 is uniform. However, it is not always necessary for the curvature of the curved portion 11e to be equal to the curvature of the curve of the inner surface 11b, so long as the thickness of the panel 11 is substantially uniform.

In addition, in the above-described embodiment, the entire front surface 11a of the panel 11 except for the peripheral portion 11d forms the curved portion 11e. However, it is not always necessary for the entire front surface 11a of the panel 11 except for the peripheral portion 1d to form the curved portion 11e. For example, for the interest of prevention of the degradation of the fluorescent screen 12, it is sufficient for at least the portion of the front surface 11a which faces the portion of the inner surface 11b where the fluorescent screen 12 is formed to form the curved portion 11e.

Furthermore, the invention is applicable not only to a projector of the front projection type in which a picture is projected on the front face of a screen but also to a projector of the rear projection type in which a picture is projected on the rear face of a screen via mirrors.

Obviously many modifications and variations of the present invention are possible in the light of the above teachings. It is therefore to be understood that within the scope of the appended claims the invention may be practiced otherwise than as specifically described.

What is claimed is:

1. A projection type cathode ray tube comprising:
a main body comprising a panel on which at least phosphor is provided, the panel being formed in the inwardly curved form with a uniform thickness; and
a cooling system which has an opening facing the panel, and is filled with a cooling liquid for cooling the panel so that the cooling system makes contact with the panel through the opening.

2. A projection type cathode ray tube as claimed in claim 1, wherein the panel is mounted on the front surface of the panel with a sealing member in between, and only a portion of the panel which contacts the sealing member is polished.

3. A projection type cathode ray tube as claimed in claim 2, wherein polishing is performed using an abrasive containing cerium oxide.

4. A projection type cathode ray tube as claimed in claim 2, wherein the peripheral portion of the outer surface of the panel is a substantially planar surface.

5. A projection type cathode ray tube as claimed in claim 1, wherein the sealing member is an adhesive containing silicone resin.

6. A projection type cathode ray tube as claimed in claim 5, wherein the adhesive contains silicone rubber.

7. A projection type cathode ray tube as claimed in claim 1, wherein the cooling system has another opening which is at the position facing the opening and is blocked by a lens mounted on the cooling system.

8. A projection type cathode ray tube as claimed in claim 7, wherein the lens is mounted on the cooling system with an O ring in between.

9. A projection type cathode ray tube as claimed in claim 1, wherein the cooling liquid held in the cooling liquid holder is a clear liquid having a refractive index substantially equal to the refractive index of the panel.

10. A projection type cathode ray tube as claimed in claim 9, wherein the clear liquid is a mixed solution of ethylene glycol and glycerin.
